(19) United States
(12) Patent Application Publication
(10) Pub. No.: US 2024/0195176 A1
(43) Pub. Date: Jun. 13, 2024

(54) SOLAR CHARGING SYSTEM

(71) Applicant: Goal Zero LLC, Bluffdale, UT (US)

(72) Inventors: Evan Price, Cottonwood Heights, UT (US); Keyvan Vasefi, Payson, UT (US); Sterling Robison, Cottonwood Heights, UT (US)

(21) Appl. No.: 18/534,553

(22) Filed: Dec. 8, 2023

Related U.S. Application Data
(60) Provisional application No. 63/386,625, filed on Dec. 8, 2022.

(51) Int. Cl. H02J 3/14; H02J 3/38; H02J 7/35

(52) U.S. Cl. CPC H02J 3/144; H02J 3/381; H02J 7/35; H02J 2300/24

(57) ABSTRACT

A switch device may include a first port configured to be directly coupled to a single photovoltaic module of multiple photovoltaic modules in a photovoltaic module array. The first ports may receive direct current power generated by the photovoltaic module. The switch device may also include a second port configured to be coupled to a connection system for coupling the photovoltaic modules to an electrical grid and a third port configured to be coupled to an energy storage system. The switch device may also include a switch configured to couple the first port to the second port in a first configuration and to couple the first port to the third port in a second configuration.

### CROSS REFERENCE TO RELATED APPLICATIONS

This patent application claim priority to U.S. Provisional Patent Application Ser. No. 63/386,625, filed Dec. 8, 2022, which is incorporated herein by reference.

### FIELD

The embodiments discussed herein are related to a solar charging system.

### BACKGROUND

Solar panels may be used to generate electricity. For example, solar panels may be installed on structures and may be tied into an electrical grid that is coupled to the structure. As a result, electrical power generated by the solar panels may be used to power the structure and/or to power the electrical grid.

The subject matter claimed herein is not limited to embodiments that solve any disadvantages or that operate only in environments such as those described above. Rather, this background is only provided to illustrate one example technology area where some embodiments described herein may be practiced.

### SUMMARY

A switch device may include a first port configured to be directly coupled to a single photovoltaic module of multiple photovoltaic modules in a photovoltaic module array. The first ports may receive direct current power generated by the photovoltaic module. The switch device may also include a second port configured to be coupled to a connection system for coupling the photovoltaic modules to an electrical grid and a third port configured to be coupled to an energy storage system. The switch device may also include a switch configured to couple the first port to the second port in a first configuration and to couple the first port to the third port in a second configuration.

### BRIEF DESCRIPTION OF THE DRAWINGS

Example embodiments will be described and explained with additional specificity and detail through the use of the accompanying drawings in which:

FIG. 1 illustrates an environment that includes a photovoltaic energy system;

FIG. 2 illustrates an environment for solar charging;

FIG. 3 illustrates another environment for solar charging;

FIG. 4 illustrates another environment for solar charging;

FIG. 5 illustrates a flowchart of an example method to perform solar charging; and

FIG. 6 illustrates an example system that may be used for solar charging.

### DETAILED DESCRIPTION

Solar panels may be deployed on buildings, arrays, or other structures. In some circumstances, the solar panels may be deployed and connected to power system of a home and to an electrical grid. Connection to the electrical grid may allow the power generated by the solar panels to be fed back to the electrical grid. In some circumstances, a battery system may be deployed that may accept power generated by the solar panels. Alternately or additionally, a system may be deployed that allows power generated by the solar panels to be directed to the power system of a home and to an electrical grid or to the battery system.

The present disclosure describes a system that may be used to direct power generated by solar panels to an electrical grid or to a battery system. The system may include a switch device coupled to each solar panel individually. The switch device may be configured to electrically couple the solar panel to which the switch device is coupled to either an electrical grid or to a energy storage system, such as a battery. In these and other embodiments, each switch device may include a first, second, and third port. The first port may be coupled to the solar panel, the second port may be coupled to an electrical grid, and the third port may be coupled to the energy storage system. In these and other embodiments, the switch device may selectively couple the first port to one of either of the second port and the third port based on a control signal. In these and other embodiments, the control signal may be generated by the energy storage system.

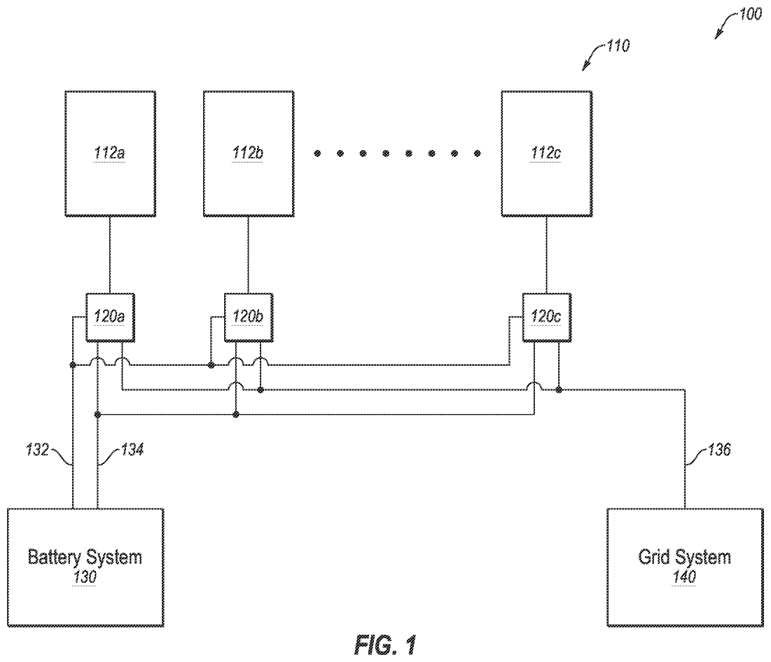

FIG. 1 illustrates an environment 100 that includes a photovoltaic (PV) energy system, in accordance with some embodiments of the present disclosure. The environment 100 includes a PV module array 110, a first switch device 120a, a second switch device 120b, and a third switch device 120c, referred to collectively as the switch devices 120, an energy storage system 130, and a connection system 140.

In some embodiments, the PV module array 110 may include any number and type of PV module. FIG. 1 illustrates a first PV module 112a, a second PV module 112b, and a third PV module 112c, referred to collectively as the PV modules 112 in the PV module array 110. However, the PV module array 110 may include any number of PV modules and any type of configuration, such as series or parallel configurations.

The PV modules 112 may be any type of PV modules, such as monocrystalline, polycrystalline, passivated emitter and rear contact panels, or thin-film panels. Each of the PV modules 112 may be configured to generate direct current (DC) power, i.e., a DC voltage and a DC current in response to light. The current and the voltage generated by each of the PV modules 112 may be similar or different. Each of the PV modules 112 may include one or more photovoltaic cells that are coupled together physically and electronically within a housing. The housing may include a positive connection and a ground or negative connection. The DC power generated by the PV modules 112 may be output via the positive and negative connections.

Each of the PV modules 112 may be coupled to one of the switch devices 120. For example, the first PV module 112a may be coupled to the first switch device 120a, the second PV module 112b may be coupled to the second switch device 120b, and the third PV module 112c may be coupled to the third switch device 120c. The PV modules 112 may be coupled to the switch devices 120 via the positive and negative connections such that the switch devices 120 receive the DC power generated by the PV modules 112. In these and other embodiments, no device or electrical component may be coupled between the PV modules 112 and the switch devices 120 besides an electrical conductor that electrically couples the PV modules 112 and the switch devices 120. Each of the switch devices 120 may include a first port, a second port, and a third port. Each of the ports may include a positive terminal and a negative terminal for an electrical connection.

The switch devices 120 may each include a two-state switch that is configured to direct DC power from the first port to one of the second port and the third port. Alternately or additionally, the switch devices 120 may include a third state that may be connected to a floating port. The floating port may be a port in a non-connected state, such as electrically unconnected.

In some embodiments, the switch devices 120 may be configured to obtain the DC power directly from the PV modules 112. For example, the switch devices 120 may obtain the DC power on the first ports of the switch devices 120. In these and other embodiments, each of the switch devices 120 may obtain DC power from one of the PV modules 112. Thus, in the environment 100, the number of switch devices 120 may equal the number of PV modules 112. Alternately or additionally, the number of switch devices 120 may be less than the number of PV modules 112.

In some embodiments, each of the switch devices 120 may be coupled to the energy storage system 130 and the connection system 140. For example, the second ports of the switch devices 120 may be coupled to the energy storage system 130 and the third ports of the switch devices 120 may be coupled to the connection system 140. In these and other embodiments, based on a configuration of the switch devices 120, the switch devices 120 may direct the DC power from the PV modules 112 to either the energy storage system 130 or the connection system 140. For example, in a first configuration the first port of the switch devices 120 may be electrically coupled to the second port of the switch devices 120. As such, the switch devices 120 may direct the DC power to the energy storage system 130. In a second configuration the first port of the switch devices 120 may be electrically coupled to the third port of the switch devices 120. As such, the switch devices 120 may direct the DC power to the connection system 140 or a floating connection.

In some embodiments, each of the switch devices 120 may be coupled to a control line 132 configured to provide a control signal to the switch devices 120. The configuration of the switch devices 120 may be controlled based on the control signal obtained over the control line 132. The control line 132 may also be coupled to the energy storage system 130. In these and other embodiments, the energy storage system 130 may be configured to generate the control signal that may control the configuration of the switch devices 120. In some embodiments, all of the switch devices 120 may have a similar configuration. In these and other embodiments, each of the PV modules 112 may provide DC power to one of the energy storage system 130 and the connection system 140 through the switch devices 120. Alternately or additionally, one or more of the switch devices 120 may have the first configuration and one or more of the switch devices 120 may have the second configuration. As such, a first set of the PV modules 112 may provide DC power to the energy storage system 130 and a second set of the PV modules 112 may provide DC power to the connection system 140.

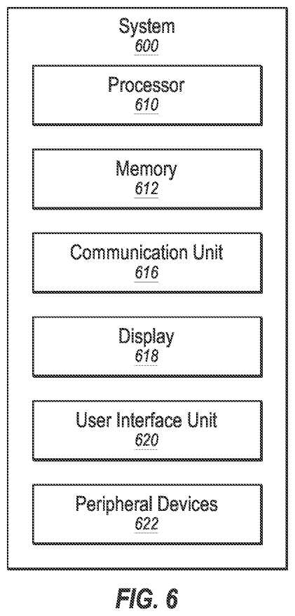

In some embodiments, the energy storage system 130 may be electrically coupled to each of the switch devices 120. The energy storage system 130 may include one or more energy storage devices, such as one or more batteries. The one or more batteries may be any type or configuration of batteries. The energy storage system 130 may include electronics configured to assist in charging the one or more energy storage devices and providing power to one or more loads from the one or more energy storage devices. For example, the energy storage system 130 may include an inverter and other electrical components to convert energy between AC and DC. Alternately or additionally, the energy storage system 130 may include one or more processors, FPGAs, microcontrollers, or other digital or analog circuitry configured to interpret and/or to execute program instructions and/or to process data such as described with respect to FIG. 6. In these and other embodiments, the components configured to process data may perform one or more operations to charging the one or more energy storage devices and providing power to one or more loads from the one or more energy storage devices.

In some embodiments, the energy storage system 130 may be configured to obtain the DC power from one or more of the PV modules 112 via the switch devices 120. The energy storage system 130 may be configured to use the DC power from the PV modules 112 to charge one or more batteries. In these and other embodiments, the energy storage system 130 may condition the DC power, such as by adjusting a voltage of the DC power, before charging the one or more energy storage devices in the energy storage system.

In some embodiments, the energy storage system 130 may be further configured to generate the control signal to provide over the control line 132 to each of the switch devices 120. In some embodiments, the energy storage system 130 may generate a single control signal that may be provided to each of the switch devices 120. For example, the control signal may be voltage. Alternately or additionally, the energy storage system 130 may generate two or more control signals for the switch devices 120. For example, the energy storage system 130 may generate a different control signal for each of the switch devices 120. As another example, the energy storage system 130 may generate a first control signal for a first set of the switch devices 120 and a second control signal for a second set of the switch devices 120. In this example, the first control signal may set the switch devices 120 in the first configuration and the second control signal may set the switch devices 120 in the second configuration.

The connection system 140 may be electrically coupled to each of the switch devices 120. In these and other embodiments, the connection system 140 may be configured to obtain the DC power from one or more of the PV modules 112 via the switch devices 120. The connection system 140 may be configured to convert the DC power to AC power and apply the AC power to an electrical grid or to power a building, unit, structure, device, or system using the AC power. In some embodiments, the connection system 140 may include multiple different components. For example, the connection system 140 may include one or more inverters among other devices. The inverters may be configured to convert the DC power to AC power. In these and other embodiments, the connection system 140 may include multiple microinverters. Each of the microinverters may be coupled to one or more of the switch devices 120. Alternately or additionally, the connection system 140 may include a single inverter that may be coupled to all of the switch devices 120.

The switch devices 120 may be configured to allow the DC power generated by the PV modules 112 of the PV module array 110 to be provided to the energy storage system 130 and/or to the connection system 140. In these and other embodiments, the configuration of the switch devices 120 where every one of the PV modules 112 in the PV module array 110 is coupled to a different one of the switch devices 120 may allow the environment 100 to be constructed and/or the energy storage system 130 added to an existing environment that already includes the PV module array 110 and the connection system 140 without multiple changes to the existing environment. For example, a building may include a PV module array that is tied to a connection system, such as a MLPE system, where each of the PV modules in the PV module array is coupled to a microinverter. In this example, a switch may be coupled between each of the PV modules and each of the microinverters. Adding the switches may be performed by disconnecting the microinverters from each of the PV modules and placing the switch devices between the PV modules and the microinverters. By adding the switches, the PV modules may be connected to an energy storage system. As such, an existing environment may be more easily supplemented with an energy storage system that is configured to charge a battery from the PV modules than in current configurations.

As another example, the environment 100 may be more easily reconfigured to include additional PV modules in the PV module array 110 with the switch devices 120 than without the switch devices 120. For example, adding additional PV modules may involve adding one or more switch devices and coupling the switch devices to the energy storage system 130 and the connection system 140. However, no other adjustments to the current configuration of the environment 100 may be required. In contrast, in some current systems added additional PV modules to an existing environment may be more difficult.

Modifications, additions, or omissions may be made to FIG. 1 without departing from the scope of the present disclosure. For example, in some embodiments, the control line 132 may not be part of the energy storage system 130. In these and other embodiments, another system may be coupled to the control line 132 may be configured to provide the control signal to the switch devices 120. As another example, the environment 100 may not include the connection system 140. In these and other embodiments, the third ports of the switch devices 120 may be open, e.g., not connected to a wire or line. Alternately or additionally, the environment 100 may not include the energy storage system 130. In these and other embodiments, the second ports of the switch devices 120 may be open, e.g., not connected to a wire or line.

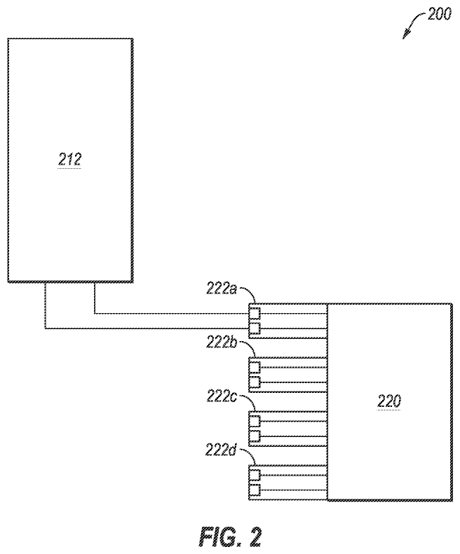

FIG. 2 illustrates an environment 200 for solar charging, in accordance with some embodiments of the present disclosure. The environment 200 includes a PV module 212 and a switch device 220. The switch device 220 may be an example of one of the switch devices 120 of FIG. 1.

In some embodiments, the switch device 220 may include a first port 222a, a second port 222b, a third port 222c, and a fourth port 222d, referred to collectively as the ports 222. The first port 222a may be coupled to the PV module 212. The second port 222b may be coupled to a connection system. The third port 222c may be coupled to an energy storage system. The fourth port 222d may be coupled to a control system. In some embodiments, the control system may be part of the energy storage system.

In some embodiments, the first port 222a may include two terminals for coupling to a positive power line and a negative power line coupled to the PV module 212. In these and other embodiments, the PV module 212 may generate DC power and may output the DC power via the positive power line and the negative power line to the first port 222a.

The second port 222b may include two terminals for coupling to a positive power line and a negative power line coupled to a connection system. The third port 222c may include two terminals for coupling to a positive power line and a negative power line coupled to an energy storage system. The fourth port 222d may include two terminals for coupling to an input control line and an output control line. The input control line may be coupled to a control system configured to generate a control signal and provide the control signal to a first connector of the fourth port 222d. In some embodiments, the control signal may be a voltage, such as a 6, 12, 24, 30, or 38 voltage. In some embodiments, the control signal may be a voltage below under 60 volts. The output control line may be coupled to one or more other switch devices and may output the control signal received on the input control line.

In some embodiments, in response to the voltage being present on a first terminal of the fourth port 222d, the switch device 220 may be placed in a first configuration and output the voltage on a second connector of the fourth port 222d. In the first configuration, the switch device 220 may electrically couple the first port 222a to the third port 222c. In response to the voltage not being present on the first connector of the fourth port 222d, the switch device 220 may be placed in a second configuration. In the second configuration, the switch device 220 may electrically couple the first port 222a to the second port 222b. Alternately or additionally, in response to the voltage being present the switch device 220 may be placed in the second configuration and in response to the voltage not being present the switch device 220 may be placed in the first configuration. In these and other embodiments, each of the switch devices 220 coupled to the control device may be placed in the same configuration.

Modifications, additions, or omissions may be made to FIG. 2 without departing from the scope of the present disclosure. For example, in some embodiments, the control signal may not be constant voltage signal. Alternately or additionally, the control signal may be a serial data signal where each of the switch devices includes a different address and the configuration of each of the switch devices may be controlled individually. For example, serial data signaling protocols, such as a RS 232 protocol, for serial data transmission may be used to allow a control device to communicate with the switch devices.

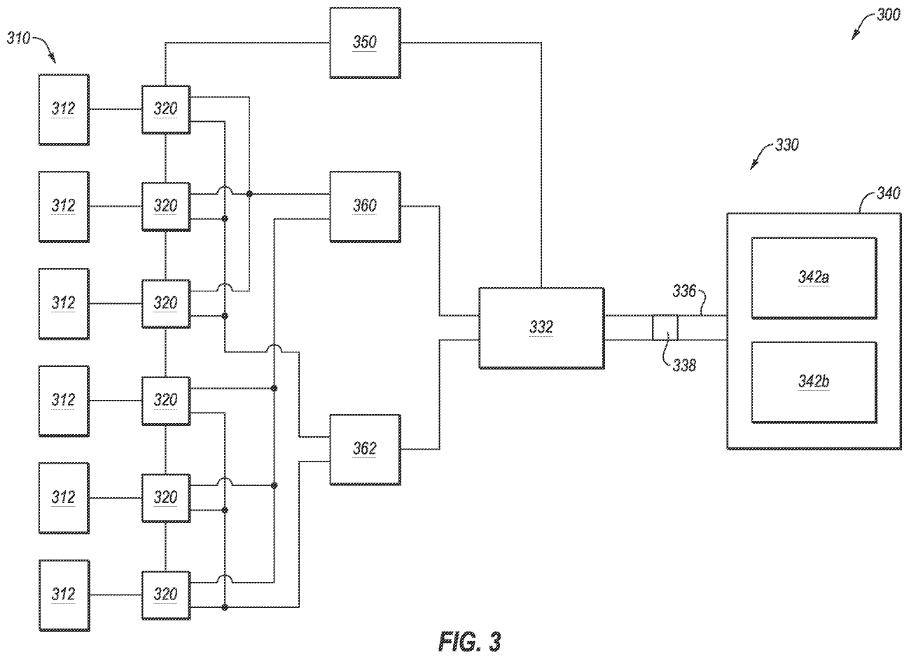

FIG. 3 illustrates an environment 300 for solar charging, in accordance with some embodiments of the present disclosure. The environment 300 includes a PV module array 310 that includes PV modules 312, switch devices 320, an energy storage system 330, a switch 350, a first power combination device 360, and a second power combination device 362.

In some embodiments, the PV module array 310 and the PV modules 312 may be analogous to the PV module array 110 and the PV modules 112 of FIG. 1 and thus no further description is provided with respect to FIG. 3. Every PV modules 312 may be coupled to one of the switch devices 320. The switch devices 320 may be analogous to the switch devices 120 and 220 of FIGS. 1 and 2 and thus no further description is provided with respect to FIG. 3.

In some embodiments, the outputs of the switch devices 320 configured to be provided to the energy storage system 330 may be coupled to the first power combination device 360 and the second power combination device 362. In these and other embodiments, the first power combination device 360 may be coupled to one or more of the positive power lines between the switch devices 320 and the energy storage system 330. In these and other embodiments, the first power combination device 360 may be configured to combine the DC power from each of the switch devices 320 onto a single positive power line. In these and other embodiments, the first power combination device 360 may be coupled to the interface device 332 via the single positive power line.

In some embodiments, the second power combination device 362 may be coupled to one or more of the negative power lines between the switch devices 320 and the energy storage system 330. In these and other embodiments, the second power combination device 362 may be configured to combine the grounds from each of the switch devices 320 onto a single negative power line, e.g. a ground line. In these and other embodiments, the second power combination device 362 may be coupled to the interface device 332 via the single negative power lines.

In some embodiments, the energy storage system 330 may include an interface device 332, a connector device 336 that includes a disconnect device 338, a battery unit 340, a first battery 342a and a second battery 342b, referred to collectively as the batteries 342. In these and other embodiments, the interface device 332 may be configured to provide an interface for coupling a battery unit 340 to the switch devices 320 via a connector device 336. The interface device 332 may include multiple connection points to receive the positive and negative power lines from the first power combination device 360 and the second power combination device 362. The interface device 332 may further include a connection to couple a control signal line from the switch devices 320 to the interface device 332. Alternately or additionally, the interface device 332 may further include a connection for coupling an AC power line coupled to a system, such as a connection system, to the interface device 332. Alternately or additionally, the interface device 332 may include a connection for coupling a switch 350 to the interface device 332.

In some embodiments, the interface device 332 may be configured to provide connections for each of the switch 350, the control signal line, and the positive and negative power lines from the first power combination device 360 and the second power combination device 362, to a port that may be coupled to the connector device 336. In these and other embodiments, the connector device 336 may be configured to provide connection between the port and the battery unit 340 for each of the switch 350, the control signal line, and the positive and negative power lines from the first power combination device 360 and the second power combination device 362. Thus, the battery unit 340 may be coupled to each of the switch 350, the control signal line, and the positive and negative power lines from the first power combination device 360 and the second power combination device 362 via the connector device 336.

As described with respect to FIG. 3, the interface device 332 and the connector device 336 may provide the DC power from the PV module array 310 to the battery unit 340 and the battery 342. In these and other embodiments, the disconnect device 338 may be coupled between the portions of the connector device 336 configured to carry the DC power from the interface device 332 to the battery unit 340. The disconnect device 338 may be configured to electrically disconnect the battery unit 340 from the switch devices 320 in response to a current of the DC power being greater than a threshold. For example, the disconnect device 338 may include a fuse that may break in response to a current passing through the fuse that is larger than a threshold. The disconnect device 338 may be further configured to electrically disconnect the battery unit 340 from the switch devices 320 in response to a temperature of the disconnect device 338 being greater than a threshold. For example, as a current of the DC power passes through the connector device 336 and the disconnect device 338, the current may not be sufficient to break the fuse, however the current may be large enough to cause a temperature of the disconnect device 338 and the connector device 336 to rise. In response to the temperature being greater than a threshold, the disconnect device 338 may electrically disconnect the battery unit 340 from the switch devices 320. In some embodiments, in response to a voltage being over a particular threshold, the disconnect device 338 may direct the power to ground which may cause the temperature of the disconnect device 338 to rise resulting in the disconnect device 338 electrically disconnecting the battery unit 340 from the switch devices 320.

In some embodiments, the battery unit 340 may include a control system configured to control the switch devices 320. For example, the battery unit 340 may generate a control signal that may control the configuration of the switch devices 320. In these and other embodiments, the interface device 332 and the connector device 336 may provide the control signal from the battery unit 340 to the switch devices 320 via the control signal line.

In some embodiments, the battery unit 340 may be configured to obtain a signal from the switch 350 and an indication of AC power on the AC power line coupled to the interface device 332. In these and other embodiments, the control system of the battery unit 340 may be configured to control the configuration of the switch devices 320 based on the signal from the switch 350 and the indication of the AC power. For example, in response to the switch 350 being in a first state, the control system may only select a second configuration of the switch devices 320 so that no DC power is provided to the energy storage system 330. As another example, in response to the switch 350 being in a second state, the control system may select a first configuration of the switch devices 320 so that DC power is provided to the energy storage system 330 from the PV module array 310 or may select the second configuration of the switch devices 320 so that no DC power is provided to the energy storage system 330. Alternately or additionally, in response to the switch 350 being in a second state, the control signal may direct the switch devices 320 to a third state to electrical isolate the PV module array 310. In these and other embodiments, the switch 350 being in the second state may override any control signals from the battery unit 30.

As another example, in response to an indication of AC power being available, the control system may select a second configuration of the switch devices 320 so that no DC power is provided to the energy storage system 330. In this example, in response to an indication of no AC power being available, the control system may select a first configuration of the switch devices 320 so that DC power is provided to the energy storage system 330 from the PV module array 310. Thus, the PV module array 310 may charge the energy storage system 330 in response to an indication of no AC power being available.

In some embodiments, the control system may be configured to control charging of the batteries 342 using the DC power from the PV module array 310. Alternately or additionally, the control system may be configured to control discharging of the batteries 342. In these and other embodiments, the battery unit 340 may convert the DC power to AC power. In these and other embodiments, the battery 342 may be discharged and charged at the same time and/or in overlapping time periods.

In these and other embodiments, the interface device 332 may include multiple ports. Each of the ports may be coupled to a different PV module array 310. In these and other embodiments, each port may be coupled to the same AC power line and switch, such as the switch 350. Alternately or additionally, each of the ports may be coupled to a different switch.

Modifications, additions, or omissions may be made to FIG. 3 without departing from the scope of the present disclosure. For example, in some embodiments, the environment 300 may include more battery 342. Alternately or additionally, the environment 300 may include an additional PV module array 310 that may be coupled to the interface device 332. In these and other embodiments, the energy storage system 330 may include a second battery unit 340 that may be coupled to a second port of the interface device 332 via a second connector device 336. Thus, the interface device 332 may be used to couple more than one PV module array 310 to different battery units 340 and batteries 342.

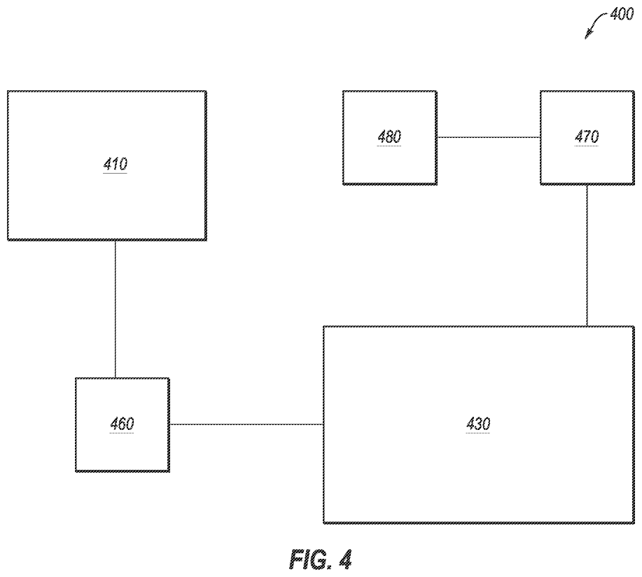

FIG. 4 illustrates an environment 400 for solar charging, in accordance with some embodiments of the present disclosure. The environment 400 includes a PV module array 410, an energy storage system 430, power combination devices 460, a transfer switch panel 470, and a main panel 480. The environment 400 may provide an example usage of an energy storage system 430 that is charged from the PV module array 410 using switch devices as described in this disclosure.

In some embodiments, the PV module array 410 may be analogous to the PV module array 110 of FIG. 1 and thus no further description is provided with respect to FIG. 4. The energy storage system 430 may be analogous to the energy storage systems 130 and 330 of FIGS. 1 and 3 and thus no further description is provided with respect to FIG. 4.

As illustrated in FIG. 4, the PV module array 410 may provide DC power to the energy storage system 430 via the power combination devices 460. The energy storage system 430 may provide AC power to the transfer switch panel 470. The transfer switch panel 470 may control how AC power is connected to one or more circuits coupled to the transfer switch panel 470. For example, the transfer switch panel 470 may determine to send AC power from the energy storage system 430 to the one or more circuits or may send AC power from the main panel 480 to the one or more circuits.

As an example, an AC power line from the main panel 480 may be coupled to the energy storage system 430 as described with respect to FIG. 3. In response to the AC power line not being powered by the main panel 480, the energy storage system 430 may provide AC power to the transfer switch panel 470 to power the one or more circuits. In these and other embodiments, the energy storage system 430 may provide a control signal to switch devices so that DC power from the PV module array 410 is used to charge the energy storage system 430. In response to the AC power line being powered by the main panel 480, the energy storage system 430 may not provide AC power to the transfer switch panel 470 and the energy storage system 430 may provide a control signal to the switch devices so that DC power is provided to an inverter that generates AC power that may be provided to a provider of AC power for the main panel 480. Modifications, additions, or omissions may be made to FIG. 4 without departing from the scope of the present disclosure.

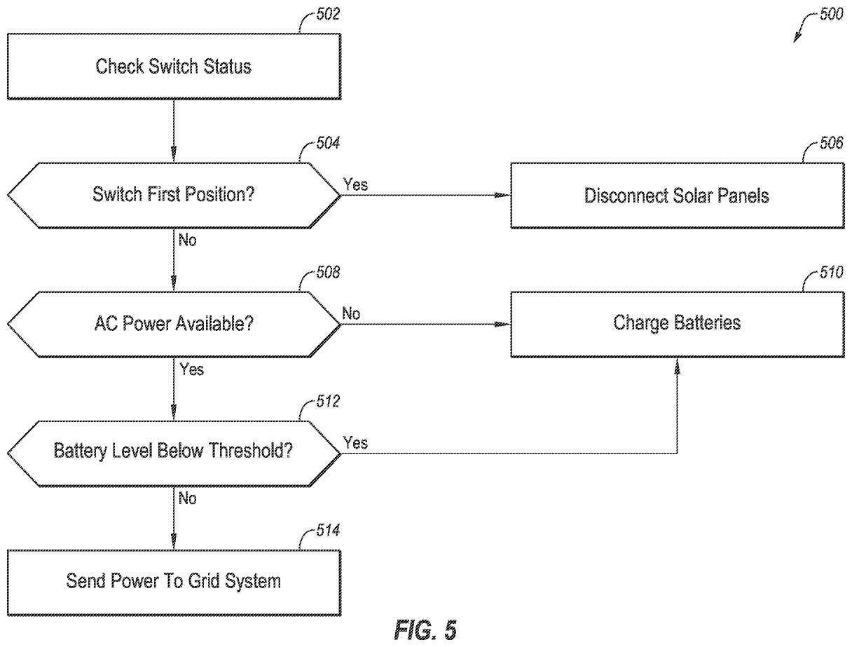

FIG. 5 illustrates a flowchart of an example method 500 to perform solar charging. The method 500 may be arranged in accordance with at least one embodiment described in the present disclosure. One or more operations of the method 500 may be performed, in some embodiments, by a device or system, such as the energy storage system 130 or 330 of FIGS. 1 and 3 or another device or combination of devices or control systems. In these and other embodiments, the method 500 may be performed based on the execution of instructions stored on one or more non-transitory computer-readable media. Although illustrated as discrete blocks, various blocks may be divided into additional blocks, combined into fewer blocks, or eliminated, depending on the desired implementation.

The method 500 may begin at block 502, where a switch status may be checked. The switch may be an emergency switch that may be configured to direct disconnection of PV modules in a PV module array from other systems, such as a connection system or an energy storage system. Alternately or additionally, the switch may be an emergency switch that may be configured to direct disconnection of PV modules in a PV module array from an energy storage system and connect the PV modules to a connection system. In some embodiments, the switch may include two positions. In a first position, the switch may indicate to disconnect the PV modules from other systems. In a second position, the switch may indicate that the PV modules may be connected to other systems.

At block 504, it may be determined if the switch is in the first position. In response to the switch being in the first position, the method 500 may proceed to block 506. In response to the switch not being in the first position, the method 500 may proceed to block 508.

At block 506, the PV modules of the PV module array may be disconnected from the energy storage system and/or the connection system. In these and other embodiments, DC power generated by the PV modules may be provided to a floating node.

At block 508, it may be determined if AC power is available. For example, it may be determined if AC power is available from the connection system, such as an electrical grid or AC power source that does not include the energy storage system. In response to AC power being available, the method 500 may proceed to block 512. In response to the AC power not being available, the method 500 may proceed to block 510.

At block 510, one or more batteries of the energy storage system may be charged using DC power generated by the PV modules. In these and other embodiments, the DC power from the PV modules may be directed to the energy storage system using switch devices as described in this disclosure. Charging of the one or more batteries may be performed by causing all of the switch devices to be in a configuration to provide DC power to the energy storage system. Alternately or additionally, charging of the one or more batteries may be performed by causing one or more of the switch devices to be in a configuration to provide the DC power to the energy storage system. In these and other embodiments, a number of the PV modules to use to charge the one or more batteries may vary based on an amount of DC power generated per PV module, an number of batteries to be charged, an amount to charge each battery, a time for charging each battery, a time of day when charging occurs, an amount of sunlight left in a day, an estimated future usage of the one or more batteries, among other factors. In these and other embodiments, which of the PV modules to use for charging may vary based on the factors discussed above. Alternately or additionally, other factors such as an efficiency, age, location, configuration, inverter technology, and other factors regarding the PV modules may be used to select from among the PV modules to include for providing DC power to charge the one or more batteries.

At block 512, it may be determined if a battery level is below a threshold. In response to the battery level being below the threshold, the method 500 may proceed to block 510. In response to the battery level not being below the threshold, the method 500 may proceed to block 514.

The threshold may be selected based on a user input. For example, the threshold may be 10, 20, 40, 60, or 80 percent of capacity of the battery. Alternately or additionally, the threshold may be selected based on a usage pattern of the battery. For example, if the battery is drained to 60 percent of the battery during a typical usage, e.g., 40 percent of the capacity of the battery is used during a typical usage pattern, the threshold may be selected such that the battery maintains a capacity of the usual usage. Alternately or additionally, the threshold may be selected based on usage of the battery that maximizes aspects of the battery, such as battery life, battery stability, and/or other aspects of the battery.

At block 514, DC power generated by the PV modules may be provided to a connection system. For example, the DC power may be converted to AC power and provided to a power grid operated by a company or governmental agency.

It is understood that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

For example, in some embodiments, the method 500 may further include after block 510 a step of determining if the batteries are charged. In response to the batteries being charged, the method 500 may proceed to block 508. In response to the batteries not being charged, the method may continue at block 510. As another example, at block 510, the method 500 may further include charging the batteries using AC power from the grid. For example, in response to the method determining at block 512 to charge the batteries, the AC power may be available. In these and other embodiments, the batteries may be charged using the AC power or the DC power from the solar panels. In these and other embodiments, a determination may be made to use the AC power or the DC power based on a cost of the AC power and/or other factors.

FIG. 6 illustrates an example system 600 that may be used for solar charging. The system 600 may be arranged in accordance with at least one embodiment described in the present disclosure. The system 600 may include a processor 610, memory 612, a communication unit 616, a display 618, a user interface unit 620, and a peripheral device 622, which all may be communicatively coupled. In some embodiments, the system 600 may be part of any of the systems or devices described in this disclosure. For example, the system 600 may be part of the energy storage system 130 of FIG. 1 and may be configured to perform one or more of the tasks described above with respect to the energy storage system 130. For example, the system 600 may be configured to generate the control signals provided to the switch devices 120.

Generally, the processor 610 may include any suitable special-purpose or general-purpose computer, computing entity, or processing device including various computer hardware or software modules and may be configured to execute instructions stored on any applicable computer-readable storage media. For example, the processor 610 may include a microprocessor, a microcontroller, a parallel processor such as a graphics processing unit (GPU) or tensor processing unit (TPU), a digital signal processor (DSP), an application-specific integrated circuit (ASIC), a Field-Programmable Gate Array (FPGA), or any other digital or analog circuitry configured to interpret and/or to execute program instructions and/or to process data.

Although illustrated as a single processor in FIG. 6, it is understood that the processor 610 may include any number of processors distributed across any number of networks or physical locations that are configured to perform individually or collectively any number of operations described herein. In some embodiments, the processor 610 may interpret and/or execute program instructions and/or process data stored in the memory 612. In some embodiments, the processor 610 may execute the program instructions stored in the memory 612.

For example, in some embodiments, the processor 610 may execute program instructions stored in the memory 612 that are related to transcription presentation such that the system 600 may perform or direct the performance of the operations associated therewith as directed by the instructions. In these and other embodiments, the instructions may be used to perform one or more operations of the method 500 of FIG. 5.

The memory 612 may include computer-readable storage media or one or more computer-readable storage mediums for carrying or having computer-executable instructions or data structures stored thereon. Such computer-readable storage media may be any available media that may be accessed by a general-purpose or special-purpose computer, such as the processor 610.

By way of example, and not limitation, such computer-readable storage media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media.

Computer-executable instructions may include, for example, instructions and data configured to cause the processor 610 to perform a certain operation or group of operations as described in this disclosure. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

The communication unit 616 may include any component, device, system, or combination thereof that is configured to transmit or receive information over a network. In some embodiments, the communication unit 616 may communicate with other devices at other locations, the same location, or even other components within the same system. For example, the communication unit 616 may include a modem, a network card (wireless or wired), an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, etc.), and/or the like. The communication unit 616 may permit data to be exchanged with a network and/or any other devices or systems described in the present disclosure.

The display 618 may be configured as one or more displays, like an LCD, LED, Braille terminal, or other type of display. The display 618 may be configured to present data as directed by the processor 610.

The user interface unit 620 may include any device to allow a user to interface with the system 600. For example, the user interface unit 620 may include a mouse, a track pad, a keyboard, buttons, camera, and/or a touchscreen, among other devices. The user interface unit 620 may receive input from a user and provide the input to the processor 610. In some embodiments, the user interface unit 620 and the display 618 may be combined.

The peripheral devices 622 may include one or more devices. For example, the peripheral devices may include a microphone, an imager, and/or a speaker, among other peripheral devices. In these and other embodiments, the microphone may be configured to capture audio. The imager may be configured to capture images. In some embodiments, the speaker may broadcast audio received by the system 600 or otherwise generated by the system 600.

Modifications, additions, or omissions may be made to the system 600 without departing from the scope of the present disclosure. For example, in some embodiments, the system 600 may include any number of other components that may not be explicitly illustrated or described. Further, depending on certain implementations, the system 600 may not include one or more of the components illustrated and described.

As indicated above, the embodiments described herein may include the use of a special purpose or general-purpose computer (e.g., the processor 610 of FIG. 6) including various computer hardware or software modules, as discussed in greater detail below. Further, as indicated above, embodiments described herein may be implemented using computer-readable media (e.g., the memory 612 of FIG. 6) for carrying or having computer-executable instructions or data structures stored thereon.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A system comprising:
an energy storage system including one or more batteries that is configured to obtain direct current power from each of a plurality of photovoltaic modules in a photovoltaic module array; and
a plurality of switch devices, each of the switch devices including:
a first port configured to be directly coupled to a single photovoltaic module of the plurality of photovoltaic modules in the photovoltaic module array such that each of the plurality of photovoltaic modules are directly coupled to a different one of the plurality of switch devices and the first ports receive direct current power generated by the photovoltaic modules;
a second port configured to be coupled to a connection system for coupling the photovoltaic modules to an electrical grid; and
a third port configured to be coupled to the energy storage system,
wherein each switching device is configured to couple the first port to the second port in a first configuration and to couple the first port to the third port in a second configuration,
wherein the energy storage system is configured to provide a control signal to each of the plurality of switch devices to select between the first configuration and the second configuration.

2. The system of claim 1, wherein the switch is further configured to couple the first port to a disconnected position in a third configuration.

3. The system of claim 2, wherein the disconnected position is a floating position where the switch is only electrically connected to the single photovoltaic module.

4. The system of claim 1, wherein each of the first port, the second port, and the third port include a positive terminal and a negative terminal.

5. The system of claim 1, wherein the first port is directly coupled to the single photovoltaic module such that only an electrical conductor is electrically coupled between the first port and the single photovoltaic module.

6. The system of claim 1, wherein a first group of the plurality of switch devices are configured in the first configuration and a second group of the plurality of switch devices are configured in the second configuration at the same time.

7. The system of claim 1, further comprising a power combination device configured to be couple between the third ports of a group of two or more of the plurality of switch devices and the energy storage system.

8. The system of claim 7, further comprising a second power combination device configured to be couple between the third ports of the group of two or more of the plurality of switch devices and the energy storage system, wherein the power combination device is coupled between first terminals of the group of two or more of the plurality of switch devices and the energy storage system and the second power combination device is coupled between second terminals of the group of two or more of the plurality of switch devices and the energy storage system.

9. The system of claim 1, wherein energy storage system includes a processor configured to execute instructions to cause or direct performance of operations, the operations comprising:
determine an availability of power from the electrical grid; and
in response to no power being available, direct the plurality of switch devices to the second configuration.

10. The system of claim 9, wherein the operations further comprise:
determine a second availability of power from the electrical grid;
in response to the power being available, determine if a power level of the energy storage system satisfies a threshold; and
in response to the power level of the energy storage system satisfying the threshold, direct the plurality of switch devices to the first configuration.

11. A switch device, comprising:
a first port configured to be directly coupled to a single photovoltaic module of a plurality of photovoltaic modules in a photovoltaic module array and the first ports receive direct current power generated by the photovoltaic modules;
a second port configured to be coupled to a connection system for coupling the photovoltaic modules to an electrical grid;
a third port configured to be coupled to an energy storage system; and
a switch configured to couple the first port to the second port in a first configuration and to couple the first port to the third port in a second configuration.

12. The switch device of claim 11, wherein a configuration of the switch is selected based on a control signal from the energy storage system.

13. The switch device of claim 11, wherein the switch is further configured to couple the first port to a disconnected position in a third configuration.

14. The switch device of claim 13, wherein the disconnected position is a floating position where the switch is only electrically connected to the single photovoltaic module.

15. The switch device of claim 11, wherein each of the first port, the second port, and the third port include a positive terminal and a negative terminal.

16. The switch device of claim 11, wherein the first port is directly coupled to the single photovoltaic module such that only an electrical conductor is electrically coupled between the first port and the single photovoltaic module.

17. A method comprising:
determining an availability of power from an electrical grid; and
in response to no power being available, directing a plurality of switch devices to a first configuration, each of the plurality of switch devices including:
a first port configured to be directly coupled to a single photovoltaic module of a plurality of photovoltaic modules in a photovoltaic module array such that each of the plurality of photovoltaic modules are directly coupled to a different one of the plurality of switch devices and the first ports receive direct current power generated by the photovoltaic modules;
a second port configured to be coupled to a connection system for coupling the photovoltaic modules to the electrical grid; and
a third port configured to be coupled to an energy storage system, wherein the first configuration of a switch device couples the first port to the third port.

18. The method of claim 17, further comprising:
determining a second availability of power from the electrical grid;
in response to the power being available, determining if a power level of the energy storage system satisfies a threshold; and
in response to the power level of the energy storage system satisfying the threshold, directing the plurality of switch devices to a second configuration where a switch device couples the first port to the second port.

19. The method of claim 18, wherein the plurality of switch devices are directed to the second configuration in place of retaining the plurality of switch devices in the first configuration when the power level of the energy storage system does not satisfy the threshold.

20. The method of claim 17, further comprising:
determining a status of a disconnect switch; and
in response to the disconnect switch being in a first position, determining the availability of power from the electrical grid.
